(19) United States
(12) Patent Application Publication
(10) Pub. No.: US 2007/0149251 A1
(43) Pub. Date: Jun. 28, 2007

(54) Signal calibration apparatus in a smart antenna system

(75) Inventor: Min Jeon, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/645,402

(22) Filed: Dec. 26, 2006

(30) Foreign Application Priority Data
Dec. 26, 2005 (KR) 2005-0129433

(51) Int. Cl. H04M 1/00

(52) U.S. Cl. 455/562.1

(57) ABSTRACT

A signal calibration apparatus in a smart antenna system is provided. In the signal calibration apparatus, a beamformer and calibrator sends a calibration signal through each of N transmitters, extracts the calibration signal from a signal received from a calibration receiver, and calibrates a transmission signal in a transmission path corresponding to the transmitter using the extracted calibration signal during a downlink time period. During an uplink time period, the beamformer and calibrator sends a calibration signal through a calibration transmitter, extracts the calibration signal from a signal received from each of N receivers, and calibrates a reception signal in a reception path corresponding to the receiver using the extracted calibration signal during an uplink time period.

### PRIORITY

This application claims priority under 35 U.S.C. § 119 to an application filed in the Korean Intellectual Property Office on Dec. 26, 2005 and assigned Serial No. 2005-129433, the contents of which are incorporated herein by reference.

### BACKGROUND OF THE INVENTION

1. Field of the Invention

The present invention relates generally to a Time Division Duplex (TDD) smart antenna system, and in particular, to a signal calibration apparatus.

2. Description of the Related Art

A smart antenna system is a communication system that uses a plurality of antennas to automatically optimize a radiation pattern and/or a reception pattern according to the signal environment.

A Base Station (BS) steers a data signal of a desired strength only in the direction of an intended Mobile Station (MS) with minimum power by beam forming using the smart antenna system. Therefore, power is saved for signal transmission, compared to omni-directional signal transmission to all Mobile Stations (MSs) within the coverage area of the BS. Even within the same coverage area, an intended MS is actively located and a signal is transmitted/received with directionality to/from the MS, minimizing interference to MSs in the other directions. As a consequence, the BS may allocate saved power to other MSs and the decrease of inter-neighbor cell interference increases the channel capacity of the BS.

In the smart antenna system, the beamforming that applies directionality in a predetermined direction takes place in a digital baseband part of the BS and the resulting beams must be provided with integrity in phase and amplitude to the antennas, prior to radiation in the air. However, the phases and amplitudes of the beam signals are distorted due to the non-linearity of an amplifier, an upconverter/downconverter, and a cable in the BS. Accordingly, the smart antenna technology must be implemented alongside calibration technology to compensate for the phase and amplitude distortions. The overall performance of the smart antenna technology is dependent dominantly on calibration accuracy. In other words, accurate calibration improves the performance of the smart antenna technology by minimizing of amplitude and phase mismatches. The calibration technology applies commonly to the downlink from the BS to the MS and the uplink from the MS to the BS.

FIG. 1 is a block diagram of a conventional signal calibration apparatus in a smart antenna system.

Referring to FIG. 1, an array antenna 111 having N elements is connected to N transceivers, which are in turn connected to a beamformer and calibrator 100. A beam formed in the beamformer and calibrator 100 is radiated from the array antenna 111 through N transmitters in the N transceivers. The N transmitters, each having an amplifier and a mixer, form different paths and the phase and amplitude characteristics of a signal are different in each path. Accordingly, calibration transmission and reception paths is required, and a calibration transceiver 131 for the calibration transmission and reception paths is provided to calibrate the N transmission/reception paths.

For calibration of the N transmission paths, the beamformer and calibrator 100 generates a calibration signal and inserts it in a first transmission path. The calibration signal is over-sampled in a Digital UpConverter (DUC) 101-1, modulated to an Radio Frequency (RF) signal in a Transmission (Tx) module 102-1 to 109-lin the transmission path, and sent to each antenna via a coupler 110-1. The modulated calibration signal is coupled in the coupler 110-1 and sent to the calibration transceiver 131. Specifically, the coupler 110-1 extracts part of the signal that has passed through the transmission module 102-1 to 109-1 and provides the extracted signal to an N:1 divider 124. A signal output from the N:1 divider 124 is switched to a calibration reception module 125 to 129 by a 2:1 switch 123 and fed back to the beamformer and calibrator 100 through a Digital DownConverter (DDC) 130. The beamformer and calibrator 100 detects the amplitude and phase characteristics of the signal in the first transmission path using the created calibration signal and the feedback calibration signal, and calibrates the first transmission path based on the amplitude and phase characteristics. In the same manner, second through N^{th} transmission paths are calibrated.

For calibration of the N reception paths, the beamformer and calibrator 100 generates a calibration signal and inserts it in the calibration transmission path. The calibration signal is modulated to an RF signal through a DUC 118 and in a Tx module 119 to 122 and then switched to N couplers 110-1 to 100-N. The calibration signals from the N couplers 110-1 to 110-N are fed back to the beamformer and calibrator 100 through the N receivers. The beamformer and calibrator 100 detects the amplitude and phase characteristics of the signal from each reception path and calibrates the reception paths based on the amplitude and phase characteristics.

As described above, the smart antenna system needs additional calibration transmission and reception paths and a calibration-only transceiver for calibrating the amplitude and phase of a signal from each path, aside from the main paths. Therefore, when the system uses an N-element array antenna, a total of (N+1) transceivers including the calibration transceiver are required. As a result, cost is increased and the configuration of the smart antenna system becomes more complicated.

### SUMMARY OF THE INVENTION

An object of the present invention is to substantially solve at least the above problems and/or disadvantages and to provide at least the advantages below. Accordingly, an object of the present invention is to provide a signal calibration apparatus in a smart antenna system.

Another object of the present invention is to provide an apparatus for calibrating a signal by using one of a plurality transceivers used for a smart antenna for the dual purpose of signal transmission/reception and signal calibration in a TDD smart antenna system.

The above objects are achieved by providing a signal calibration apparatus in a smart antenna system.

In the signal calibration apparatus, during a downlink time period, a beamformer and calibrator generates a calibration signal for each of N transmitters, sends the calibration signal through the each transmitter, extracts the calibration signal from a signal received from a calibration receiver co-functioning as a general receiver, and calibrates a transmission signal in a transmission path corresponding to the each transmitter using the extracted calibration signal. During an uplink time period, the beamformer and calibrator generates a calibration signal for each of N receivers, sends the calibration signal through a calibration transmitter co-functioning as a general transmitter, extracts the calibration signal from a signal received from each of N receivers, and calibrates a reception signal in a reception path corresponding to the each receiver using the extracted calibration signal. Each of the N transmitters and receivers converts the signal received from the beamformer and calibrator to an RF signal, sends the RF signal to a predetermined array antenna, couples the calibration signal sent to the array antenna, and sends the coupled calibration signal to the calibration receiver during the downlink time period, and modulates the calibration signal received from the calibration receiver to a baseband signal and provides the baseband signal to the beamformer and calibrator during the uplink time period. Here, the calibration transmitter and receiver is one transmitter and receiver from among the N transmitter and receivers. The calibration transmitter and receiver modulates the calibration signal received from the each of the N transmitters and receivers to a baseband signal and provides the baseband signal to the beamformer and calibrator during the downlink time period, and modulates the calibration signal received from the beamformer and calibrator to an RF signal, divides the RF signal into N signals, and provides the N signals to the N transmitters and receivers during the uplink time period.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional signal calibration apparatus in a smart antenna system; and

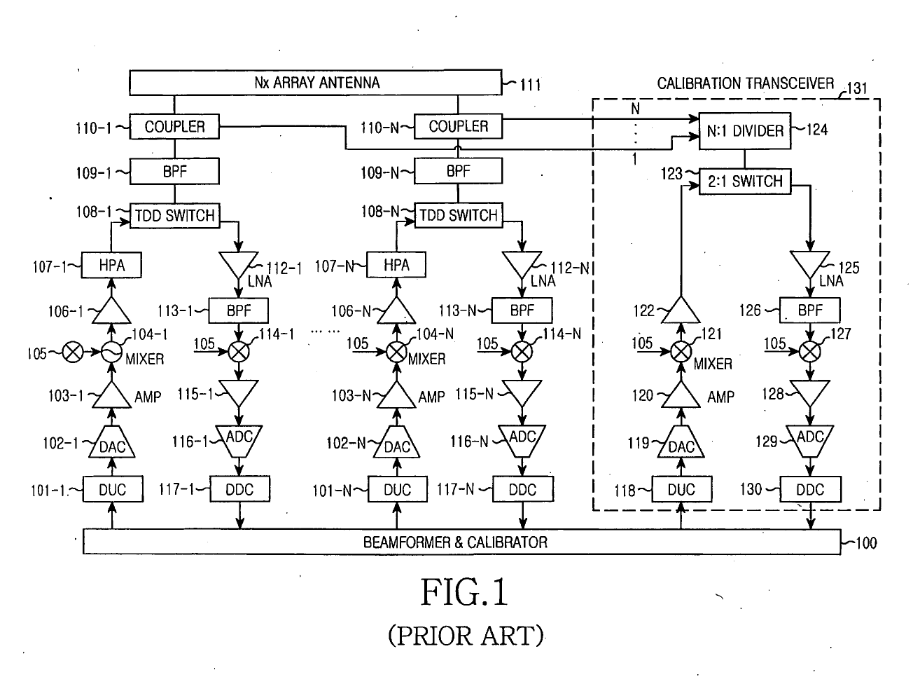

FIG. 2 is a block diagram of a signal calibration apparatus in a TDD smart antenna system according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Typically, a TDD signal is configured so as to include a downlink signal area in which a BS sends a signal, an uplink signal area in which an MS sends a signal to the BS, a Transmission/Reception Transit Gap (TTG) interposed between the downlink and the uplink, and a Reception/Transmission Transit Gap (RTG) interposed between the uplink and the downlink. In view of the TDD nature of the signal, a receiver is disabled in the downlink period and a transmitter is disabled in the uplink period in the BS.

In accordance with the present invention, one of a plurality of transceivers for a smart antenna co-functions as a calibration transceiver based on the nature of the TDD signal, which obviates the need for a separately procured calibration transceiver. Specifically, one of N receivers kept inactive during the downlink link period is used as a calibration receiver for transmitter calibration during the downlink period. One of N transmitters kept inactive during the uplink period is used as a calibration transmitter for receiver calibration during the uplink period.

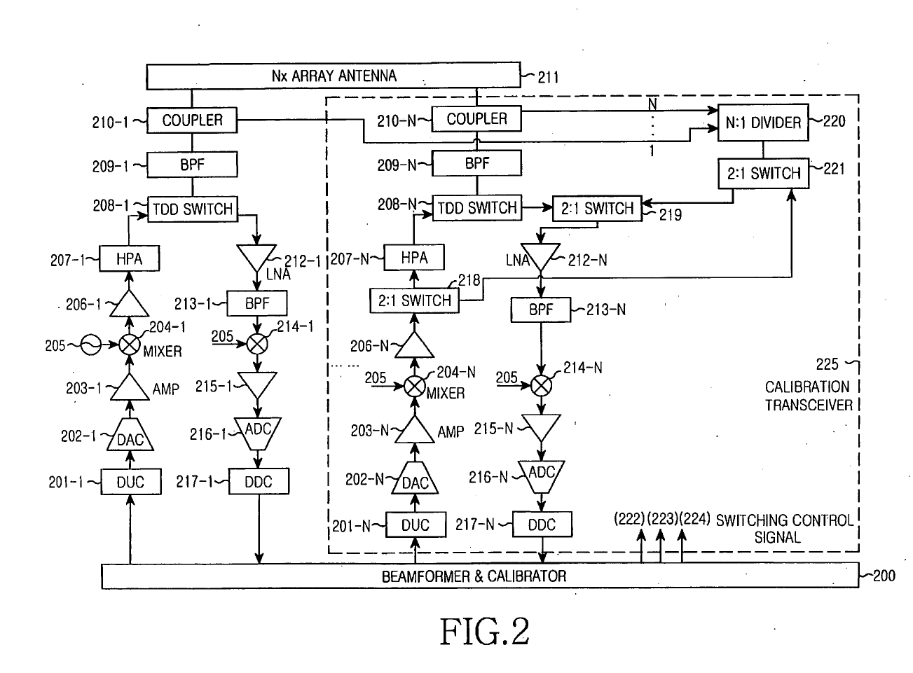

FIG. 2 is a block diagram of a signal calibration apparatus in a TDD smart antenna system according to the present invention. It is assumed that the TDD smart antenna system includes an array antenna 211 with N elements. The array antenna 211 is connected to N transceivers connected to a beamformer and calibrator 200. The N transceivers each have an amplifier and a mixer and form different paths. One of the N transceivers co-functions as a calibration transceiver 225. The calibration transceiver 225 further includes an N:1 divider 220, a first 2:1 switch 221, a second 2:1 switch 219, and a third 2:1 switch 218, as compared to a general transceiver.

Referring to FIG. 2, an apparatus for calibrating transmission signals in N transmission paths includes the beamformer and calibrator 200, a DUC 201, a Tx module 202 to 207, a transceiver control board 208 and 209, and a coupler 210 in each transmitter, and the N:1 divider 220, the first and second 2:1 switches 221 and 219, a Receiving (Rx) module 212 to 216, and a DDC 217 in the calibration transceiver 225.

The beamformer and calibrator 200 generates a calibration signal for each of the N transmission paths, transmits the calibration signal in the transmission path, extracts the calibration signal from a signal received in a calibration reception path of the calibration transceiver 225, and calibrates a transmission signal in the transmission path with the calibration signal. The beamformer and calibrator 200 controls the first and second 2:1 switches 221 and 219 of the calibration transceiver 225 by means of switching control signals 222 and 223.

In each transmitter, the DUC 201 oversamples the calibration signal received from the beamformer and calibrator 200. The Tx module 202 to 207 modulates the oversampled signal to an RF signal and the transceiver control board 208 and 209 sends the RF signal to the coupler 210 and the array antenna 211. The coupler 210 couples the calibration signal and sends the coupled signal in the calibration reception path, i.e. to the N:1 divider 220 in the calibration transceiver 225.

The Tx module 202 to 207 includes a Digital-to-Analog Converter (DAC) 202, first and second amplifiers 203 and 206, a local oscillator 205, a mixer 204, and a High Power Amplifier (HPA) 207. The DAC 202 converts the digital oversampled signal received from the DUC 201 to an analog signal, the first amplifier 203 amplifies the analog signal to a predetermined power level, and the mixer 204 converts the amplified signal to a predetermined frequency band by the local oscillator 205. The second amplifier 206 amplifies the signal received from the mixer 204 to a predetermined power level. The HPA 207 also amplifies the amplified signal to a predetermined power level and provides the amplified signal to the transceiver control board 208 and 209.

The transceiver control board 208 and 209 includes a TDD switch 208 and a first Band Pass Filter (BPF) 209. The TDD switch 208 switches the Tx module 202 to 207 to the first BPF 209 to support the transmission path. The first BPF 209 outputs only a signal falling within a predetermined frequency range in the signal received from the Tx module 202 to 207 to the coupler 210.

In the calibration transceiver 225, the N:1 divider 220 provides the coupled calibration signal received from each of the N transmission paths to the first 2:1 switch 221. The first 2:1 switch 221 switches the received signal to the second 2:1 switch 219 according to the switching control signal 222 received from the beamformer and calibrator 200. The second 2:1 switch 219 switches the received signal to an Rx module 212-N to 216-N according to the switching control signal 223 received from the beamformer and calibrator 200. The Rx module 212-N to 216-N modulates the received signal to a baseband signal and provides the baseband signal to the beamformer and calibrator 200 through a DDC 217-N. The second 2:1 switch 219 switches the signal received from the first 2:1 switch 221 to the Rx module 212-N to 216-N according to the switching control signal 223 that determines whether the calibration transceiver 225 is to serve as a general receiver or a calibration receiver.

The Rx module 212-N to 216-N includes first and second Low Noise Amplifiers (LNAs) 212-N and 215-N, a second BPF 213-N, a mixer 214-N, a local oscillator 205, and an ADC 216-N. The first LNA 212-N amplifies the calibration signal received from the second 2:1 switch 219 to a predetermined power level, and the second BPF 213-N outputs a signal falling within a predetermined frequency range in the amplified calibration signal to the mixer 214-N. The mixer 214-N converts the received signal to a predetermined frequency band by the local oscillator 205. The second LNA 215-N amplifies the signal received from the mixer 214-N to a predetermined power level. The ADC 216-N converts the amplified analog signal to a digital signal and provides the digital signal to the DDC 217-N.

An apparatus for calibrating signals received in N reception paths includes the beamformer and calibrator 200, a DUC 201-N, a Tx module 202-N to 206-N, the third 2:1 switch 218, the first 2:1 switch 221, and the N:1 divider 220 of the calibration transceiver 225, and the coupler 210, the transceiver control board 208 and 209, an Rx module 212 to 216, and the DDC 217 of each of N receivers.

The beamformer and calibrator 200 generates a calibration signal for each of the N reception paths, transmits the calibration signal in the calibration transmission path of the calibration transceiver 225, and calibrates a signal received in the reception path with the calibration signal received in the reception path. The beamformer and calibrator 200 controls the third and first 2:1 switches 218 and 221 of the calibration transceiver 225 by means of switching control signals 224 and 222.

In the calibration transceiver 225, the DUC 201-N oversamples the calibration signal received from the beamformer and calibrator 200. The Tx module 202-N to 206-N modulates the oversampled signal to an RF signal and the third 2:1 switch 218 switches the RF signal to the first 2:1 switch 221 according to the switching control signal 224 received from the beamformer and calibrator 200. The first 2:1 switch 221 switches one of the received signal to the N:1 divider 220 according to the switching control signal 222 received from the beamformer and calibrator 200. The N:1 divider 220 divides the received signal into N signals and provides the N signals to the couplers 210-1 to 210-N of the respective N receivers. The first 2:1 switch 221 switches one of the second 2:1 switch 219 or the third 2:1 switch 218 to the N:1 divider 220 according to the switching control signal 222 which is determined depending on whether the calibration transceiver 225 serves as a calibration transmitter or a calibration receiver.

The Tx module 202-N to 206-N includes a DAC 202-N, first and second amplifiers 203-N and 206-N, a local oscillator 205, and a mixer 204-N. The DAC 202-N converts the digital oversampled signal received from the DUC 201-N to an analog signal, the first amplifier 203-N amplifies the analog signal to a predetermined power level, and the mixer 204-N converts the amplified signal to a predetermined frequency band by the local oscillator 205. The second amplifier 206-N amplifies the signal received from the mixer 204-N to a predetermined power level and provides the amplified signal to the third 2:1 amplifier 218. The third 2:1 switch 218 switches the received signal to an HPA 207-N to the first 2:1 switch 221 according to the switching control signal 224 which is determined depending on whether the calibration transceiver 225 serves as a general transmitter or a calibration transmitter.

In each of the N receivers, the coupler 210 outputs the signal received from the calibration transceiver 225 to the transceiver control board 208 and 209. The transceiver control board 208 and 209 switches the received signal to the Rx module 212 to 216. The Rx module 212 to 216 modulates the received signal to a baseband signal and provides the modulated signal to the beamformer and calibrator 200 through the DDC 217.

The transceiver control board 208 and 209 includes the first BPF 209 and the TDD switch 208. The first BPF 209 outputs only a signal falling within a predetermined frequency range in the signal received from the coupler 210 to the TDD switch 208. The TDD switch 208 switches the first BPF 209 to the Rx module 212 to 216 to support the reception path.

In each of the N receivers, the Rx module 212 to 216 includes first and second LNAs 212 and 215, a second BPF 213, a mixer 214, a local oscillator 205, and an ADC 216. The first LNA 212 amplifies the calibration signal received from the TDD switch 208 to a predetermined power level, and the second BPF 213 outputs a signal falling within a predetermined frequency range in the amplified calibration signal to the mixer 214. The mixer 214 converts the received signal to a predetermined frequency band by the local oscillator 205. The second LNA 215 amplifies the signal received from the mixer 214 to a predetermined power level. The ADC 216 converts the amplified analog signal to a digital signal and provides the digital signal to the DDC 217.

As described above, the TDD smart antenna system of the present invention uses one of transceivers for a smart antenna for the dual purpose of a general transceiver and a calibration transceiver for signal calibration, thereby obviating the need for using an additional calibration-only transceiver for calibrating the amplitude and phase of each path signal. Therefore, the smart antenna system is simplified in configuration and material cost is saved.

While the invention has been shown and described with reference to a certain preferred embodiment thereof, it will be understood by those skilled in the art that various changes in form and details may be made therein without departing from the spirit and scope of the invention as defmed by the appended claims.

What is claimed is:

1. A signal calibration apparatus for a Base Station (BS) in a smart antenna system, comprising:
a beamformer and calibrator for generating a calibration signal for each of N transmitters, transmitting the calibration signal through the each transmitter, extracting the calibration signal from a signal received from a calibration receiver co-functioning as a general receiver, and calibrating a transmission signal in a transmission path corresponding to the each transmitter using the extracted calibration signal during a downlink time period, and for generating a calibration signal for each of N receivers, transmitting the calibration signal through a calibration transmitter co-functioning as a general transmitter, extracting the calibration signal from a signal received from each of N receivers, and calibrating a reception signal in a reception path corresponding to the each receiver using the extracted calibration signal during an uplink time period; and
the N transmitters and receivers, each for converting the signal received from the beamformer and calibrator to a Radio Frequency (RF) signal, sending the RF signal to a predetermined array antenna, coupling the calibration signal sent to the array antenna, and transmitting the coupled calibration signal to the calibration receiver during the downlink time period, and modulating the calibration signal received from the calibration receiver to a baseband signal and providing the baseband signal to the beamformer and calibrator during the uplink time period,
wherein the calibration transmitter and receiver is one transmitter and receiver from among the N transmitter and receivers, modulates the calibration signal received from the each of the N transmitters and receivers to a baseband signal and provides the baseband signal to the beamformer and calibrator during the downlink time period, and modulates the calibration signal received from the beamformer and calibrator to an RF signal, divides the RF signal into N signals, and provides the N signals to the N transmitters and receivers during the uplink time period.

2. The signal calibration apparatus of claim 1, wherein each of the N transmitters and receivers comprises:
a Digital UpConverter (DUC) for oversampling the calibration signal received from the beamformer and calibrator during the downlink time period;
a transmission module for modulating the oversampled signal to the RF signal during the downlink time period;
a transceiver control board for sending the RF signal to the array antenna during the downlink time period and sending a signal received from a coupler to a receiving module during the uplink time period;
the coupler for coupling the calibration signal sent to the array antenna and providing the coupled calibration signal to the calibration receiver during the downlink time period, and providing the calibration signal received from the calibration transmitter to the transceiver control board during the uplink time period;
the receiving module for modulating the calibration signal received from the transceiver control board to the baseband signal during the uplink time period; and
a Digital DownConverter (DDC) for providing the baseband signal to the beamformer and calibrator during the uplink time period.

3. The signal calibration apparatus of claim 2, wherein the transmission module comprises:
a Digital-to-Analog Converter (DAC) for converting the oversampled digital signal received from the DUC to an analog signal;
a first amplifier for amplifying the analog signal to a predetermined power level;
a mixer for converting the amplified signal to a predetermined frequency band by means of a local oscillator;
a second amplifier for amplifying the calibration signal received from the mixer to a predetermined power level; and
a High Power Amplifier (HPA) for amplifying the amplified calibration signal to a predetermined power level.

4. The signal calibration apparatus of claim 2, wherein the transceiver control board comprises:
a Time Division Duplex (TDD) switch for switching the calibration signal modulated to the RF signal to a first Band Pass Filter (BPF) during the downlink time period, and switching a calibration signal received from the first BPF to the receiving module during the uplink time period; and
the first BPF for sending a signal falling within a predetermined frequency range in the calibration signal received from the TDD switch to the array antenna during the downlink time period, and outputting a signal falling within a predetermined frequency range in the calibration signal received from the coupler to the TDD switch during the uplink time period.

5. The signal calibration apparatus of claim 2, wherein the receiving module comprises:
a first Low Noise Amplifier (LNA) for amplifying the received calibration signal to a predetermined power level;
a second BPF for outputting only a signal falling within a predetermined frequency band in the amplified signal;
a mixer for converting the filtered signal received from the second BPF to a predetermined frequency band by means of a local oscillator;
a second LNA for amplifying the converted signal to a predetermined power level; and
an Analog-to-Digital Converter (ADC) for converting the amplified analog signal to a digital signal and outputting the digital signal to the DDC.

6. The signal calibration apparatus of claim 2, wherein the calibration transmitter and receiver comprises:
an N:1 divider for providing the calibration signal received from each of the couplers of the N transmitters and receivers to the receiving module during the downlink time period, and dividing the calibration signal modulated to the RF signal into the N signals and outputting the N signals to the couplers of the N transmitters and receivers during the uplink time period;
the receiving module for converting the signal received from the N:1 divider to a baseband signal during the downlink time period;
the DDC for providing the modulated baseband signal to the beamformer and calibrator during the downlink time period;
the DUC for oversampling the calibration signal received from the beamformer and calibrator during the uplink time period; and
the transmission module for modulating the oversampled signal to the RF signal during the uplink time period.

7. The signal calibration apparatus of claim 6, further comprising:
a first 2:1 switch for switching the signal received from the N:1 divider to a second 2:1 switch during the downlink time period, and switching a signal received from a third 2:1 switch to the N:1 divider during the uplink time period;
the second 2:1 switch for switching the signal received from the first 2:1 switch to the receiving module during the downlink time period, and switching a signal received from the transceiver control board to the receiving module during the uplink time period; and
the third 2:1 switch for switching a signal received from the second amplifier of the transmission module to the HPA of the transmission module during the downlink time period, and switching a signal received from the second amplifier of the transmission module to the first 2:1 switch during the uplink time period.

8. The signal calibration apparatus of claim 7, wherein the beamformer and calibrator controls the first, second and third 2:1 switches by a switching control signal during the downlink and uplink time periods.
